(19) United States
(12) Patent Application Publication
(10) Pub. No.: US 2020/0151390 A1
(43) Pub. Date: May 14, 2020

(54) SYSTEM AND METHOD FOR PROVIDING INFORMATION FOR AN ON-DEMAND SERVICE

(71) Applicant: BEIJING DIDI INFINITY TECHNOLOGY AND DEVELOPMENT CO., LTD., Beijing (CN)

(72) Inventors: Xiangyang LI, Beijing (CN); Jingwen WANG, Beijing (CN); Junying ZHANG, Beijing (CN)

(73) Assignee: BEIJING DIDI INFINITY TECHNOLOGY AND DEVELOPMENT CO., LTD., Beijing (CN)

(21) Appl. No.: 16/744,129

(22) Filed: Jan. 15, 2020

Related U.S. Application Data
(63) Continuation of application No. PCT/CN2017/094074, filed on Jul. 24, 2017.

(51) Int. Cl. G06F 40/295; G06F 16/35; G06N 20/00; G06F 40/247

(52) U.S. Cl. CPC G06F 40/295; G06F 40/247; G06N 20/00; G06F 16/353

(57) ABSTRACT

The present disclosure relates to a system, method and non-transitory computer readable medium. The system includes at least one computer-readable storage medium including a set of instructions and at least one processor in communication with the at least one computer-readable storage medium. When executing the set of instructions, the at least one processor is directed to: receive a first electrical signal including an address text; operate logical circuits in the at least one processor to: determine a first category of the address text based on a categorization model; determine a first segmentation model based on the first category of the address text; and determine one or more segments of the address text based on the first segmentation model.

### CROSS-REFERENCE TO RELATED APPLICATIONS

This application is a continuation of International Application No. PCT/CN2017/094074, filed on Jul. 24, 2017, the contents of which are incorporated herein by reference in its entirety.

### TECHNICAL FIELD

The present disclosure relates generally to a system and method for providing information for an on-demand service, and in particular, to a system and method for determining one or more segments of an address text from a user input in an on-demand service.

### BACKGROUND

Generally, morphological analysis involves parsing texts in natural languages into segments that have independent linguistic or grammar meanings. For some languages, since there is no inter-word spacing, it may pose challenges for a computer to parse the text correctly and understand its meaning. Therefore, systems capable to analyze texts are desired.

### SUMMARY

According to an aspect of the present disclosure, a system may include at least one computer-readable storage medium including a set of instructions and at least one processor in communication with the at least one computer-readable storage medium. When executing the instructions, the at least one processor is directed to receive a first electrical signal including an address text; operate logical circuits in the at least one processor to determine a first category of the address text based on a categorization model; determine a first segmentation model based on the first category of the address text; and determine one or more segments of the address text based on the first segmentation model.

According to an aspect of the present disclosure, a method implemented on a computing device having at least one processor, at least one computer-readable storage medium; and a communication platform connected to a network may include receiving a first electrical signal including an address text; operating logical circuits in the at least one processor to determine a first category of the address text based on a categorization model; determine a first segmentation model based on the first category of the address text; and determine one or more segments of the address text based on the first segmentation model.

According to an aspect of the present disclosure, a non-transitory computer readable medium may include instructions configured to cause a computing system to receive a first electrical signal including an address text; operate logical circuits in the at least one processor to determine a first category of the address text based on a categorization model; determine a first segmentation model based on the first category of the address text; and determine one or more segments of the address text based on the first segmentation model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary network environment of providing an on-demand service, according to some embodiments;

FIG. 2 illustrates an exemplary computing device on which the on-demand service system can be implemented, according to some embodiments of the present disclosure;

FIG. 3 illustrates an exemplary mobile device on which the on-demand service can be implemented, according to some embodiments of the present disclosure;

FIG. 4A illustrates an exemplary processing engine according to some embodiments of the present disclosure;

FIG. 4B is a block diagram of an exemplary determination module 430 according to some embodiments of the present disclosure;

FIG. 5 illustrates an exemplary flowchart for determining one or more segments of an address text using the on-demand service system according to some embodiments of the present disclosure;

FIG. 6 illustrates an exemplary flowchart for analyzing the segmentation result of the first segmentation model according to some embodiments of the present disclosure; and

FIG. 7 illustrates an exemplary flowchart for determining a first segmentation model according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for purposes of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to analyzing an address text, it should also be understood that the present disclosure is not intended to be limiting. The system or method of the present disclosure may be applied to any other applications, such as, natural language processing, semantic analysis, etc. For example, the system or method of the present disclosure may be applied to search engines, human-computer interaction (HCI) applications, artificial intelligence (AI) applications, etc. The search engines, HCI applications, or AI applications may use the system of method provided herein to segment and analyze natural language texts, etc. As another example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The terms “passenger,” “requestor,” “service requester,” and “user” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The terms “service request,” “request for a service,” “requests,” “order,” and “service order” in the present disclosure are used interchangeably to refer to a request that may be initiated by a passenger, a service requestor, a user, a driver, a provider, a service provider, or the like, or any combination thereof. The service request may be accepted by any one of a passenger, a service requestor, a user, a driver, a provider, or a service provider. The service request may be chargeable or free.

The term “driver device” in the present disclosure is used to refer to a mobile terminal that is used by a service provider to provide a service or facilitate the providing of the service. The term “terminal device” in the present disclosure is used to refer to a mobile terminal that is used by a service requestor to request or order a service.

According to an aspect of the present disclosure, a system and method for determining one or more segments of an address text are provided. The system obtains an address text from a user input. The system determines a first category of the address text based on a categorization model. The system further determines a first segmentation model based on the first category of the address text. The system determines one or more segments of the address text based on the first segmentation model. By determining one or more segments of the address text, the system can determine the meaning of the address text more accurately, which can help an application, such as a map application, a search engine, or an on-demand service understand a user's intention or meaning comprehensively. Thus, the efficiency of the application is enhanced, and the user experience is also improved.

It should be noted that the text analysis in the present disclosure, which may be used in map applications, search engines, or on-demand services, such as online taxi hailing, is a newly emerged service rooted in post-Internet era. It provides the technical solutions to the users that could rise only in post-Internet era. In the pre-Internet era, when a person reads a book or talks with another person, he/she may analyze a meaning of a text based on his or her personal experience or learning (of the subject matter and/or grammar), or dictionary. Besides, the person and/or the dictionary may not have knowledge to provide comprehensive meaning of the text. Thus, people often have difficulties in reading and understanding sophisticated texts, for example, proper names (address names, geographical names). However, the online text analysis system is able to determine multiple segments of a text in response to a text input, an image input, an audio input, or a video input of a user via a computing device. The online text analysis system determines a category of the text. The online text analysis system determines a segmentation model based on the category and then determines one or more segments of the text based on the segmentation model and the text. The online text analysis system may iterate the segmentation steps and determine final segments. By determining the category of the text, the system may determine a pertinent segmentation model appropriate to the particular text. By iterating the segmentation steps, the system may avoid erratic segmentation in which the system divided a single word into multiple segments or fails to divide a compound word composed of multiple single words. Further, the segmentation model and/or the corpus of the system may be updated constantly and systematically to adapt to ever-increasing text input. The system may be able to analyze a vast of text in a very short time. Therefore, through Internet, the online text analysis system may provide a much more accurate and efficient understanding of texts that may never be met in a traditional pre-Internet scenario.

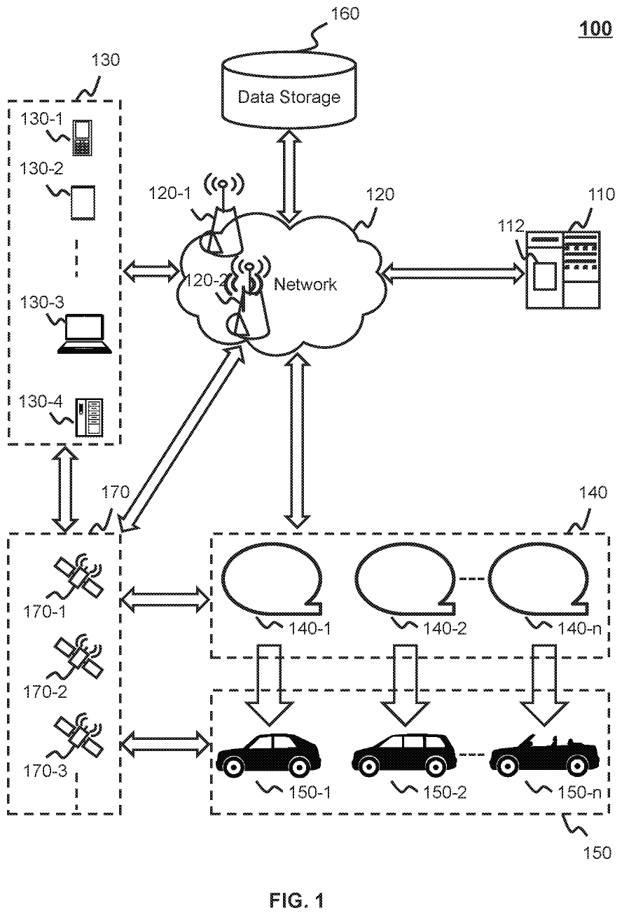

FIG. 1 illustrates an exemplary network environment of providing an on-demand service according to some embodiments. An on-demand service system 100 may be an online transportation service platform implemented in a network environment with a positioning system for providing transportation services. The on-demand service system 100 may include a server 110, a network 120, a terminal device 130, a driver device 140, a vehicle 150, and a data storage 160. The one-demand service system 100 may further communicatively connect to a positioning system 170.

The on-demand service system 100 may provide a plurality of services. Exemplary on-demand service may include a taxi hailing service, a chauffeur service, an express car service, a carpool service, a bus service, a driver hire service, and a shuttle service. In some embodiments, an on-demand service may be provided with supplementary information recommended to perform the on-demand service. The order types may include a taxi order, a luxury car order, an express car order, a bus order, a shuttle order, etc. In some embodiments, the service may be any on-line service, such as booking a meal, shopping, or the like, or a combination thereof.

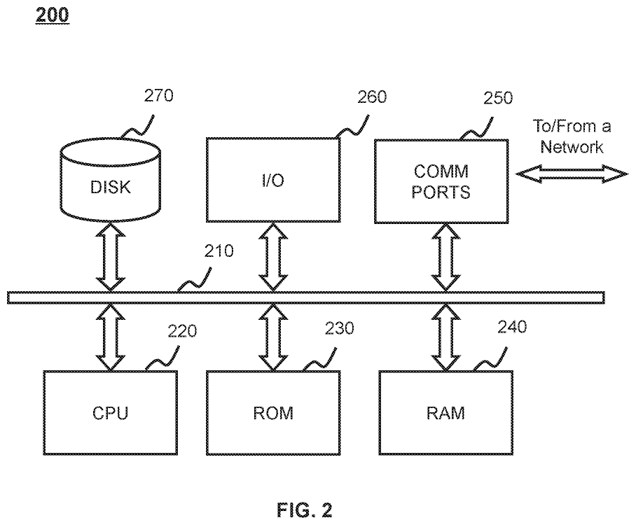

The server 110 may be a computer server. The server 110 may communicate with the terminal device 130 and/or the driver device 140 to provide various functionality of an online on-demand service. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the terminal device 130, the driver device 140, and/or the data storage 160 via the network 120. As another example, the data storage 160 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to performing one or more functions described in the present disclosure. The processing engine 112 may analyze a text from a terminal device 130. For example, the processing engine 112 may determine a category of the text based on a categorization model. As another example, the processing engine 112 may determine one or more segments of the text. In some embodiments, the processing engine 112 may perform other functions (e.g., a web search, a map search, etc.) after determining the one or more segments. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the terminal device 130, the driver device 140, the vehicle 150, the data storage 160) may send information and/or data to other component(s) in the on-demand service system 100 via the network 120. For example, the server 110 may access and/or obtain a plurality of words or phrases from the data storage 160 via the network 120. For example, the server 110 may transmit the one or more segments to the terminal device 130. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or Internet exchange points 120-1, 120-2, . . . , through which one or more components of the on-demand service system 100 may be connected to the network 120 to exchange data and/or information.

In some embodiments; a passenger may be an owner of the terminal device 130. In some embodiments, the owner of the terminal device 130 may be someone other than the passenger. For example, an owner A of the terminal device 130 may use the terminal device 130 to send a service request for a passenger B, and/or receive a service confirmation and/or information or instructions from the server 110. In some embodiments, a driver may be a user of the driver device 140. In some embodiments, the user of the driver device 140 may be someone other than the driver. For example, a user C of the driver device 140 may use the driver device 140 to receive a service request for a driver D, and/or information or instructions from the server 110. In some embodiments, a driver may be assigned to use one of the driver device 140 and/or one of the vehicles 150 for at least a certain period of time, for example, a day, a week, a month, or a year etc. In some other embodiments, a driver may be assigned to use one of the driver device 140 and/or one of the vehicles 150 on a random basis. For example, when a driver is available to provide an on-demand service, he/she may be assigned to use a driver terminal that receives the earliest request and a vehicle that is recommended to perform the type of on-demand service. In some embodiments, “passenger” and “terminal device” may be used interchangeably, and “driver” and “driver device” may be used interchangeably. In some embodiments, the driver device 140 may be associated with one or more drivers (e.g., a night-shift driver, a day-shift driver, or a driver pool by a random shifting).

The passenger may input a text, an image, an audio, or a video via the terminal device 130. The terminal device 130 may transmit the text, image, audio, or video to the server 110 via the network 120. In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the terminal device 130 may include a signal transmitter and a signal receiver configured to communicate with the positioning system 170 for locating the position of the passenger and/or the terminal device 130.

The driver may input a text, an image, an audio, or a video via the driver device 140. The driver device 140 may transmit the text, image, audio, or video to the server 110 via the network 120. The driver device 140 may include a plurality of driver devices 140-1, 140-2, . . . , 140-n. In some embodiments, the driver device 140 may be similar to, or the same device as the terminal device 130. In some embodiments, the driver device 140 may be customized to implement the online transportation service. In some embodiments, the driver device 140 and the terminal device 130 may be configured with a signal transmitter and a signal receiver to receive position information of the driver device 140 and the terminal device 130 from the positioning system 170. In some embodiments, the terminal device 130 and/or the driver device 140 may communicate with other positioning device to determine the position of the passenger, the terminal device 130, the driver, and/or the driver device 140. In some embodiments, the terminal device 130 and/or the driver device 140 may periodically send the positioning information to the server 110. In some embodiments, the driver device 140 may also periodically send the availability status to the server 110, The availability status may indicate whether a vehicle 150 associated with the driver device 140 is available to transport a passenger. For example, the terminal device 130 may send the positioning information to the server 110 every thirty minutes. As another example, the driver device 140 may send the availability status to the server every thirty minutes, and/or upon an on-demand service is completed. As another example, the terminal device 130 may send the positioning information to the server 110 each time the user logs into the mobile application associated with the online on-demand service.

In some embodiments, the driver device 140 may correspond to one or more vehicles 150. The vehicles 150 may carry the passenger and travel to the destination. The vehicles 150 may include a plurality of vehicles 150-1, 150-2, . . . 150-n. One of the plurality of vehicles may correspond to one order type. The order types may include a taxi order, a luxury car order, a limousine order, an express car order, a bus order, a shuttle order, etc.

The data storage 160 may store data and/or instructions. The data may include data related to words, data related to grammar rules, data related to a plurality of passengers, data related to a plurality of drivers, data related to a local area, data related to external environment, etc.

The data related to the words may include numerals (1, 2, one, two, first, second, etc.), names of geographical areas (continents, countries, provinces, states, counties, shires, cities, towns, boroughs, districts, neighborhoods, communities, streets, roads, etc.), names of POIs (educational institutions, public institutions, houses, shops, restaurants, hotels, companies, factories, etc.), names of nature objects (islands, mountains, hills, peaks, rocks, rivers, lakes, seas, etc.), names of directions (right (R), left (L), center, front, back, rear, up, down, south (S), west (W), north (N), east (E), southwest (SW), south-southwest (SSW), etc.), etc. The data related to the users may include user profiles. The data related to the drivers may include driver profiles. The data related to the external environment may include weather conditions, road conditions, etc. In some embodiments, the data storage 160 may store data obtained from the terminal device 130 and/or the driver device 140. For example, the data storage 160 may store log information associated with the terminal device 130. The data storage 160 may include one or more synonyms with respect to an object stored in the data storage 160. The one or more synonyms with respect to an object may be the synonymous descriptions of the object or one or more attributes or attractions associated with the object, etc. The one or more synonyms may include at least one language. For example, the synonyms of Washington D.C. may include the capital city of the United States, the District of Columbia, White House, Capitol Hill, a Chinese language of “Washington D.C.,” etc.

In some embodiments, the data storage 160 may store data and/or instructions that the server 110 may execute to provide the on-demand services described in the present disclosure. In some embodiments, data storage 160 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the data storage 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, one or more components in the on-demand service system 100 may access the data or instructions stored in the data storage 160 via the network 120. In some embodiments, the data storage 160 may be directly connected to the server 110 as a backend storage.

In some embodiments, one or more components in the on-demand service system 100 (e.g., the server 110, the terminal device 130, the driver device 140, etc.) may have permissions to access the data storage 160. In some embodiments, one or more components in the on-demand service system 100 may read and/or modify the information related to the passenger, the driver, and/or the vehicle when one or more conditions are met. For example, the server 110 may read and/or modify one or more passengers' user profile after an on-demand service order is completed.

The positioning system 170 may determine information associated with an object, for example, one or more of the terminal device 130, the driver device 140, the vehicle 150, etc. For example, the positioning system 170 may determine a current time and a current location of the terminal device 130. In some embodiments, the positioning system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, and/or a current time. The location may be in the form of coordinates, such as, a latitude coordinate and a longitude coordinate, etc. The positioning system 170 may include one or more satellites, for example, a satellite 170-1, a satellite 170-2, and a satellite 170-3. The satellites 170-1 through 170-3 may determine the information mentioned above independently or jointly. The positioning system 170 may send the information mentioned above to the terminal device 130, the driver device 140, or the vehicle 150 via the network 120.

In some embodiments, information exchanging between one or more components of the on-demand service system 100 may be initiated by way of launching the mobile application of the on-demand services on a terminal device, requesting a service, or inputting an address text via the terminal device (e.g., searching for a Pal). The object of the service request may be any product. In some embodiments, the product may include food, medicine, commodity, chemical product, electrical appliance, clothing, car, housing, luxury, or the like, or any combination thereof. In some other embodiments, the product may include a service product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a terminal 130 processes a task, such as making a determination, ranking a plurality of POIs, the terminal 130 may operate logical circuits in its processor to process such task. When the terminal 130 sends out a text (e.g., an address text) to the server 110, a processor of the terminal 130 may generate electrical signals encoding the text. The processor of the terminal 130 may then send the electrical signals to an output port. If the terminal 130 communicates with the server 110 via a wired network, the output port may be physically connected to a cable, which further transmit the electrical signal to an input port of the server 110. If the terminal 130 communicates with the server 110 via a wireless network, the output port of the terminal 130 may be one or more antennas, which convert the electrical signals to electromagnetic signals. Similarly, a driver device 140 may process a task through operation of logical circuits in its processor, and receive an instruction and/or service order from the server 110 via electrical signals or electromagnet signals, Within an electronic device, such as the terminal 130, the driver device 140, and/or the server 110, when a processor thereof processes an instruction, sends out an instruction, and/or performs an action, the instruction and/or action is conducted via electrical signals. For example, when the processor retrieves data (e.g., a plurality of names associated with an address text) from a storage medium (e.g., a data storage 160), it may send out electrical signals to a read device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates an exemplary computing device 200 on which the on-demand service system can be implemented, according to some embodiments of the present disclosure.

The computing device 200 may be a general purpose computer or a special purpose computer. Both may be used to implement an on-demand system of the present disclosure. The computing device 200 may be used to implement any component of the service as described herein. For example, the processing engine 112 of the server may be implemented on the computing device 200, via its hardware, software program, firmware, or a combination thereof. Although only one such computer is shown for convenience, the computer functions related to the service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a CPU 220, in the form of one or more processors, for executing program instructions. The exemplary computer platform may include an internal communication bus 210, program storage and data storage of different forms, for example, a disk 270, and a ROM 230, or a RAM 240, for various data files to be processed and/or transmitted by the computer. The exemplary computer platform may also include program instructions stored in the ROM 230, the RAM 240, and/or other type of non-transitory storage medium to be executed by the CPU 220. The methods and/or processes of the present disclosure may be implemented as the program instructions. The computing device 200 also includes an I/O component 260, supporting input/output between the computer, the user, and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

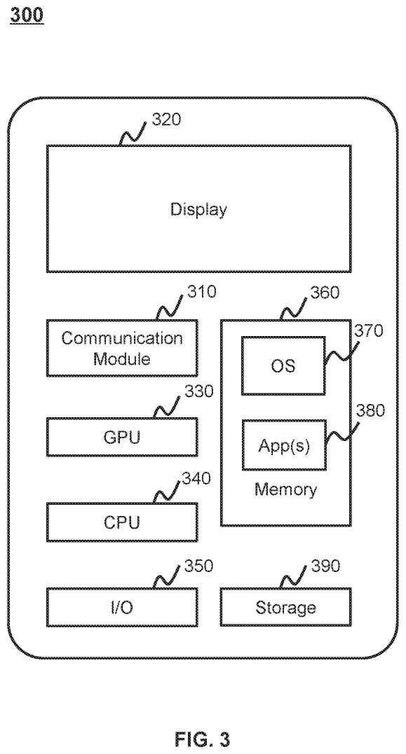

FIG. 3 illustrates an exemplary mobile device on which the on-demand service can be implemented, according to some embodiments of the present disclosure.

As illustrated in FIG. 3, the mobile device 300 may include a communication module 310, a display 320, a graphic processing unit (GPU) 330, a CPU 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser, a map application, or any other suitable mobile apps for transmitting, receiving and presenting information relating to a service order (e.g., a plurality of names associated with an address text) from the processing engine 112 and/or the data storage 160. User interactions with the information stream may be achieved via the I/O 350 and provided to the processing engine 112 and/or other components of the on-demand service system 100 via the network 120.

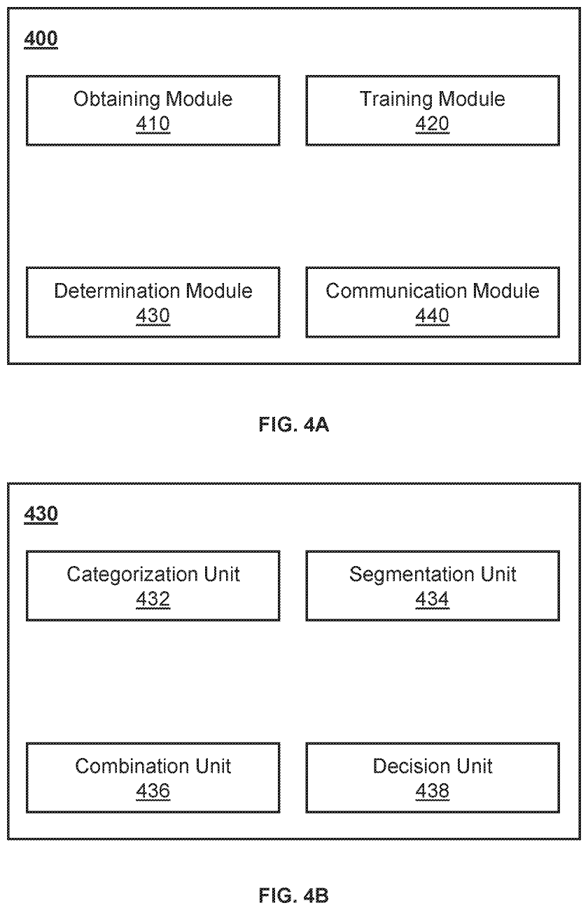

FIG. 4A illustrates an exemplary processing engine 112 according to some embodiments of the present disclosure. The processing engine 112 of the server 110 may include an obtaining module 410, a training module 420, a determination module 430, and a communication module 440. One or more modules in the processing engine 112 may be implemented by at least one processor, such as the CPU 220.

The obtaining module 410 may obtain an address text from a terminal device (e.g., the terminal device 130 or the driver device 140). The address text may refer to a name related to a location, an address related to a location, or the like, or any combination thereof. The name related to a location may include a name of a nature object, a name of an entity, a name of a building, etc., such as “Empire State Building.” The address related to a location may include information of an area, a road, a village, zip code, etc., such as “No. 225 Madison Avenue New York N.Y. 10016.” The address text may take the form of a character string. In some embodiments, the address text may include a complete word or a complete phrase. In some embodiments, the address text may include part of a complete word or a complete phrase. The address text may be generated based on a text, an image, an audio, a video, etc. For example, the address text may be generated by a user input, or by a user selection from a map. As another example, the address text may be generated by conducting an optical character recognition (OCR) on an image or a video via a camera of a terminal device. As yet another example, the address text may be generated by conducting a speech recognition on a recorded audio signal inputted via the microphone of a terminal device.

The obtaining module 410 may further obtain one or more sets of training address texts. In some embodiments, the obtaining module 410 may obtain the one or more sets of training address texts from the data storage 160 or a third party (e.g., a corpus database). In some embodiments, the obtaining module 410 may obtain two sets of training address texts. The first set of training address texts may be pre-stored in a corpus database. The second set of training address texts may be determined by modifying the first set of training address texts in the corpus database based on a semantic rule. The semantic rule may include a rule substituting the entirety or part of an address text with one or more synonyms or near-synonyms. The one or more synonyms or near-synonyms with respect to an object may be the synonymous descriptions of the object or one or more attributes or attractions associated with the object, etc. The one or more synonyms may be in at least one language. For example, the synonyms of Washington D.C. may include the capital city of the United States, the District of Columbia, White House, Capitol Hill, a Chinese language of “Washington D.C.”. In some embodiments, the semantic rule may include a rule combining at least two training address texts existing in the corpus database. For example, there are two training address texts “New York” and “city hall” in the corpus database. Based on the semantic rule, a new training address text “City Hall of New York” may be determined. In some embodiments, the semantic rule may include a rule substituting a part of a training address text with a counterpart. The counterpart may be related or the opposite to the part of the training address text. For example, there is a training address text “Left Wing of National Gallery of Art” in the corpus database. A new training address text “Right Wing of National Gallery of Art” may be determined by substituting “left” with “right” based on the semantic rule.

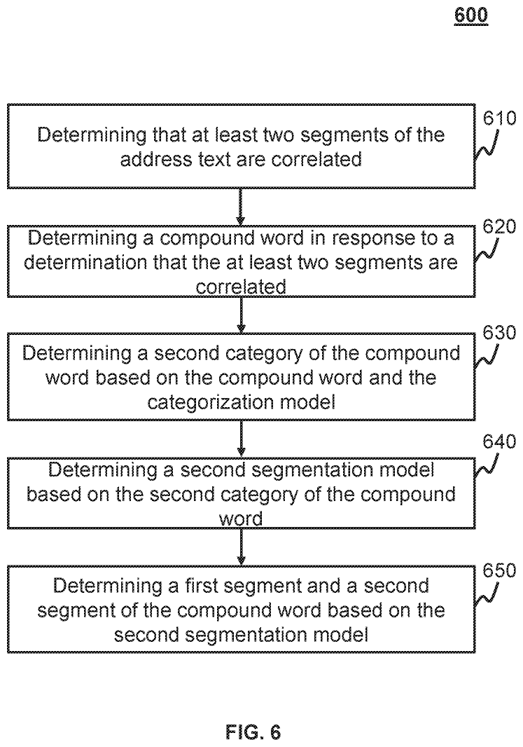

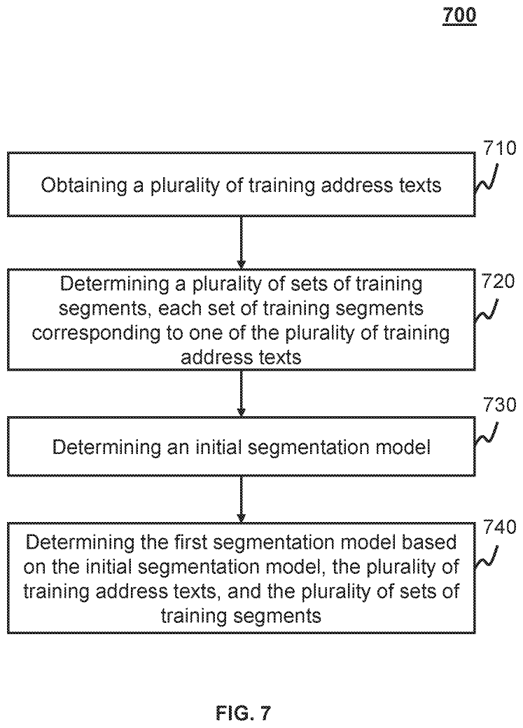

The training module 420 may obtain a segmentation model. The segmentation model may determine one or more segments based on an address text from the terminal device (e.g., the terminal device 130 or the driver device 140). The segmentation model may include a coarse-grained segmentation model and a fine-grained segmentation model. For the same address text, the coarse-grained segmentation model may determine fewer segments compared to the fine-grained segmentation model. In some embodiments, the segmentation model may be obtained by training an initial segmentation model using a vast of training data. The initial segmentation model may be configured as an initial input to the training module 420. The training module 420 may adjust the parameters of the initial segmentation model via iterative optimization. After the iterative optimization ends, the training model 420 may determine the trained segmentation model as output. The initial segmentation model may include a conditional random fields (CRF) model, a hidden Markov Model (HMM), a neural network (NN) model, etc. Details of the segmentation model and the initial segmentation model will be described in connection with FIG. 6 and FIG. 7, and the description thereof.

The determination module 430 may determine a first category of an address text. The first category of the address text may include a nature object, an area, a road, a building, an entity, etc. The nature object may include, for example a river, a mountain, a water fall, a lake, etc. The area may include a province, a state, a territory, a city, a district, a shire, a county, a town, a village, etc. The road may include a road, a street, a drive, a highway, an avenue, a motorway, etc. The building may include a description such as a building, a wing, a tower, a floor, etc. The entity may be an association, an organization, a firm, or a group of people. The entity may include a partnership, a company, a factory, a restaurant, a store, etc. In some embodiments, the determination module 430 may determine the category of the address text based on a categorization model. The categorization model may include a logistic regression (LR) model, a latent factor model (LFM), a supervised descent method (SDM) model, etc. In some embodiments, the determination module 430 may determine a second category of a compound word. The compound word may be related to the address text. The second category may be the same with or different from the first category. Details of the compound word and the second category will be described in connection with FIG. 6 and the description thereof.

The determination module 430 may determine a first segmentation model based on the first category of the address text. In some embodiments, the determination module 430 may determine a coarse-grained segmentation model when the address text is associated with a nature object or an entity. Alternatively, the determination module 430 may determine a fine-grained segmentation model when the address text is associated with an area, a road, a building, etc. In some embodiments, the determination module 430 may determine a second segmentation model based on the second category of the compound word. The second segmentation model may be the same with or different from the first segmentation model.

The determination module 430 may determine one or more segments of an address text based on the first segmentation model. In some embodiments, when at least two segments of the one or more segments are correlated, the determination module 430 may determine a compound word based on the at least two segments of the one or more segments. The determination module 430 may further determine one or more segments of the compound word based on a second segmentation model and the compound word. In some embodiments, the determination module 430 may determine final segments of the address text based on the first segmentation result and the second segmentation result.

The communication module 440 may receive information from a terminal device (e.g., the terminal device 130 or the driver device 140). For example, the communication module 430 may receive a text, an image, an audio, a video, etc. from the terminal device 130. The communication module 430 may further process the received information. The preprocessing may include, for example, an OCR, a speech recognition, a translation from one language to another, etc.

The communication module 440 may transmit one or more results related to the one or more segments of the address text to one or more terminal devices (e.g., the terminal device 130 and/or the driver device 140). The one or more results may include search results (e.g., a list of POIs in response to the address text), analysis results (e.g., a predicted intention of the user), or any other results related to the one or more segments. In some embodiments, the communication module 440 may determine multiple locations based on all or part of the one or more segments of the address text.

The obtaining module 410, the training module 420, the determination module 430, and the communication module 440 in the processing engine 112 may be connected to or communicate with each other via a wired connection, a wireless connection, or any combination thereof. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the obtaining module 410, the training module 420, the determination module 430, and the communication module 440 may be combined as a single module. For example, the training module 420 may be integrated with the determination module 430 as a single module. The single module may determine a segmentation model and determine one or more segments of an address text based on the segmentation model.

FIG. 4B is a block diagram of an exemplary determination module 430 according to some embodiments of the present disclosure. The determination module 430 may include a categorization unit 432, a segmentation unit 434, a combination unit 436, and a decision unit 438. The categorization unit 432 may determine a first category of an address text. The categorization unit 432 may further determine a second category of a compound word. The segmentation unit 434 may determine a first segmentation model based on the first category of the address text. The segmentation unit 434 may further determine a second segmentation model based on the second category of the compound word. The segmentation unit 434 may further determine the one or more segments of the address text based on the first segmentation model. The decision unit 438 may determine whether the at least two segments among the one or more segments are correlated. When the at least two segments among the one or more segments are correlated, the combination unit 436 may combine the at least two segments and determine a compound word based on the at least two segments.

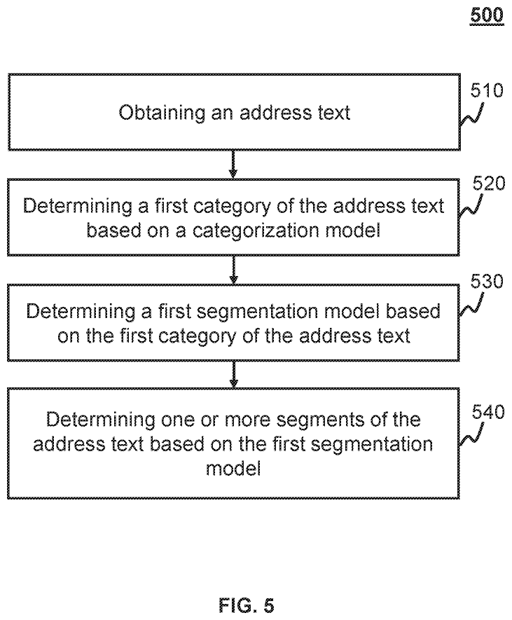

FIG. 5 illustrates an exemplary flowchart 500 for determining one or more segments of an address text using the on-demand service system, according to some embodiments of the present disclosure. The flowchart 500 may be implemented as a set of instructions in a non-transitory storage medium of the server 110 of the system 100. The CPU 220 of the server 110 may execute the set of instructions and may accordingly perform the steps in the flowchart 500.

The operations of the illustrated flowchart 500 presented below are intended to be illustrative and not limiting. In some embodiments, the flowchart 500 may be accomplished with one or more additional operations not described, and/or without one or more of the operations discussed. Additionally, the order in which the operations of the flowchart 500 as illustrated in FIG. 5 and described below is not intended to be limiting.

In step 510, the obtaining module 410 may obtain an address text. The address text may be obtained from a terminal device (e.g., the terminal device 130, or the driver device 140) that is owned and/or used by a user. In some embodiments, the address text may be generated by inputting a character string on the user interface, conducting a speech recognition on a recorded audio signal inputted via a microphone, conducting an optical character recognition on an image or a video captured by a camera, etc. The address text may include a name related to a location, an address related to a location, or the like, or any combination thereof.

In step 520, the determination module 430 may determine a first category of the address text based on a categorization model. The first category of the address text may include a nature object, an area, a road, a building, an entity, etc. The determination module 430 may determine the first category based on one or more words/characters within the address text. The one or more words/characters may be in the beginning, middle, or end of the address text. A variety of words or characters may be associated with a certain category. For example, for a name of a nature object, e.g., Lake Superior, the first word “lake” may indicate that Lake Superior is a lake. The determination module 430 may determine the first category based on a word order of a language of the address text. In some languages having a first word order, one or more words/characters related to a smaller or lower region may follow another one or more words/characters related to a larger or higher region. For example, in Chinese, a name of a city in a province may follow a name of the province. In some languages having a second word order, one or more words/characters related to a smaller or lower region may precede another one or more words/characters related to a larger or higher region. For example, in English, a name of a county in a state may precede a name of the state. When the address text is in a language with the first word order (e.g., Chinese, Japanese, etc.), the determination module 430 may determine the first category based on the last one or more words/characters of the address text. Alternatively, when the address text is described in a language with the second word order (e.g., English, German, etc.), the determination module 430 may determine the first category based on the first one or more words/characters within the address text. In some embodiments, the determination module 430 may label at least one character of the address text based on at least one position of the at least one character within an address text. The categorization model may determine the first category of the address text based the labeled characters. In some embodiments, the categorization model may be determined based on different corpora and/or languages. The categorization model may further determine the first category to be a coarse-grained category or a fine-grained category. The coarse-grained category may be suitable for being segmented to fewer segments compared to the fine-grained category. For example, the categorization model may determine the first category to be a coarse-grained category when the first category is associated with a nature object or an entity. Alternatively, the categorization model may determine the first category as a fine-grained category when the first category is associated with an area, a road, a building, etc.

In step 530, the determination module 430 may determine a first segmentation model based on the first category of the address text. The first segmentation model may include a coarse-grained segmentation model and a fine-grained segmentation model. In some embodiments, the determination module 430 may determine a coarse-grained segmentation model when the first category of the address text is a coarse-grained category. Alternatively, the determination module 430 may determine a fine-grained segmentation model when the first category of the address text is a fine-grained category. For example, when an address text is “Building 2 Digital Valley Zhonguancun Software Park Beijing,” the determination module 430 may determine the first category of the address text may be determined as a fine-grained category based on the word of “Building”. The determination module 430 may determine that the first segmentation model of the address text is a fine-grained segmentation model based on the fine-grained category.

In step 540, the determination module 430 may determine one or more segments of the address text based on the first segmentation model. For example, when the address text is “Building 2 Digital Valley Zhonguancun Software Park Beijing”, the determination module 430 may segment the address text into one or more segments. The one or more segments may include “Building 2,” “Digital,” “Valley,” “Zhongguancun,” “Software,” “Park,” and “Beijing.” In some embodiments, the determination module 430 may further analyze the result of the first segmentation model to determine a compound word. The determination module 430 may further determine a second segmentation model based on the compound word. The second segmentation model may be the same with or different from the first segmentation model. Details of the compound word and the second segmentation model may be found in FIG. 6, and the description thereof.

In some embodiments, the determination module 430 may label at least one character of the address text based on at least one position of the at least one character within an address text. The determination module 430 may determine the one or more segments based on the labeled at least one character. For example, “avenue” or “street” may be part of a road name and usually at end of the road name. The determination module 430 may determine a boundary between two segments by identifying an “avenue” or a “street” in an address text. “Avenue” and the words preceding it may be within one segment. The word following “avenue” may be within another segment. For another example, “lake” may be part of a lake name and usually at the beginning of the lake name. The determination module 430 may determine a boundary between two segments by identifying a “lake” in an address text. “Lake” and the words following it may be within one segment. The word preceding “lake” may be within another segment.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, some steps may be reduced or added. For example, one or more other options (e.g., a storing process) may be added elsewhere in the exemplary process/method 500, As another example, the determination module 430 may perform the step 530 iteratively until determining the final segments of the address text. Similar modifications should fall within the scope of the present disclosure.

FIG. 6 illustrates an exemplary flowchart 600 for analyzing the segmentation result of the first segmentation model, according to some embodiments of the present disclosure. The flowchart 600 may be implemented as a set of instructions in a non-transitory storage medium of the server 110 of the system 100. The CPU 220 of the server 110 may execute the set of instructions and may accordingly perform the steps in the flowchart 600.

The operations of the illustrated flowchart 600 presented below are intended to be illustrative and not limiting. In some embodiments, the flowchart 600 may be accomplished with one or more additional operations not described, and/or without one or more of the operations discussed. Additionally, the order in which the operations of the flowchart 600 as illustrated in FIG. 6 and described below is not intended to be limiting.

In step 610, the determination module 430 may determine that at least two segments of the address text are correlated. In some scenarios, the at least two segments may be parts of an undividable word. In some embodiments, the at least two segments are adjacent in the address text. For example, when the address text is “Building 2 Digital Valley Zhonguancun Software Park Beijing”, the first segmentation result may include “Building 2,” “Digital,” “Valley,” “Zhongguancun,” “Software,” “Park,” and “Beijing.” The determination module 430 may determine that first segmentation result is not satisfactory. The segments “Digital,” “Valley,” “Zhongguancun,” “Software,” and “Park” may be correlated.

In step 620, the determination module 430 may determine a compound word in response to a determination that the at least two segments are correlated. Taking the address text of “Building 2 Digital Valley Zhonguancun Software Park Beijing” as an example, the determination module 430 may combine the segments of “Digital,” “Valley,” “Zhongguancun,” “Software,” and “Park.” The determination module 430 may determine a compound word “Digital Valley Zhongguancun Software Park” based on the combination. The compound word may be segmented in the subsequent segmentation process.

In some embodiments, the segmentation module 430 may determine one or more compound words based on the first segmentation result. For example, for an address text “Building 2 Digital Valley Zhonguancun Software Park No. 6 Dongbeiwang West Road Haidian District Beijing”, a first segmentation result of the address text may be “Building 2,” “Digital,” “Valley,” “Zhonguancun,” “Software Park,” “No. 6,” “Dongbeiwang,” “West Road,” “Haidian,” “District,” and “Beijing.” The determination module 430 may determine two compound words based on the first segmentation result. The two compound words may include “Digital Valley Zhonguancun Software Park” and “No. 6 Dongbeiwang West Road Haidian District.” The two compound words may be segmented in the subsequent segmentation process independently.

In step 630, the determination module 430 may determine a second category of the compound word based on the compound word and the categorization model. The second category of the compound word may be the same as or different from the first category of the address text. Taking the address text “Building 2 Digital Valley Zhonguancun Software Park Beijing” as an example, the compound word may be “Digital Valley Zhongguancun Software Park.” The determination module 430 may determine a second category of the compound word based on the categorization model. The second category of the compound word may be a coarse-grained category.

In step 640, the determination module 430 may determine a second segmentation model based on the second category of the compound word. The second segmentation model may be the same as or different from the first segmentation model. Taking the address text “Building 2 Digital Valley Zhonguancun Software Park Beijing” as an example, the second segmentation model may be determined based on the second category of the compound word. The determination module 430 may determine that the second segmentation model is a coarse-grained segmentation model when the second category of the compound word is a coarse-grained category (as described in step 630).

In step 650, the determination module 430 may determine a first segment and a second segment of the compound word based on the second segmentation model. In some embodiments, the determination module 430 may determine only one segment of the compound word based on the second segmentation model. Taking the address text of “Building 2 Digital Valley Zhonguancun Software Park Beijing” as an example, the second segmentation model may segment the compound word into “Digital Valley” and “Zhongguancun Software Park” based on the second segmentation model. In some embodiments, the determination module 430 may determine whether the second segmentation result is satisfactory. In response to a determination that the second segmentation result is satisfactory, the determination module 430 may determine final segments of the address text based on the first segmentation result and the second segmentation result. In some embodiments, the determination module 430 may further determine that the segment(s) of the first segmentation and the segment(s) of the second segmentation are the final results. In response to a determination that the second segmentation result is not satisfactory, the determination module 430 may further determine a subsequent compound word based on the second segmentation result and perform a subsequent segmentation on the subsequent compound word. The determination of compound word may be iterative and end when the determination module 430 fails to determine that the segments determined in the last segmentation are correlated. In this situation, the determination module 430 may be unable to determine a compound word based on the segments. In some embodiments, the determination module 430 may determine only one segment or more than two segments based on a particular compound word.

In some embodiments, the determination module 430 may determine whether a segment of an address text is registered in a thesaurus or a corpus database. In response to a determination that the segment is not in the thesaurus or the corpus database, the determination module 430 may register the segment in the thesaurus or the corpus database. The updated thesaurus or corpus database may be used to train a segmentation model subsequently. The registration of new segments may help the thesaurus or corpus database updated.

The results of the segmentation of the address texts may be used in many applications, such as, map application, location search, etc. In some embodiments, the determination module 430 may determine a list of POIs associated with an address text based on a segmentation result of the address text. The communication module 440 may send the list of POIs to multiple terminal devices (e.g., terminal devices 130 and/or driver devices 140) for future use.

The above description is merely for illustrative purposes. It should be noted that those skilled in the art may contemplate additional or alternate steps besides the steps described in FIG. 6. For example, the flowchart 600 may further include transmitting the second segmentation result to the data storage 160 or any other components in the on-demand service system 100 by the communication module 440. As another example, the determination module 430 may determine multiple locations based on all or part of final segments of the address text.

FIG. 7 illustrates an exemplary flowchart for determining a first segmentation model, according to some embodiments of the present disclosure. The flowchart 600 may be implemented as a set of instructions in a non-transitory storage medium of the server 110 of the system 100. The CPU 220 of the server 110 may execute the set of instructions and may accordingly perform the steps in the flowchart 700.

The operations of the illustrated flowchart 700 presented below are intended to be illustrative and not limiting. In some embodiments, the flowchart 700 may be accomplished with one or more additional operations not described, and/or without one or more of the operations discussed. Additionally, the order in which the operations of the flowchart 700 as illustrated in FIG. 7 and described below is not intended to be limiting.

In step 710, the training module 420 may obtain a plurality of training address texts. The plurality of training address texts may be from a known corpus stored in the data storage 160 or a third party (e.g., a corpus database), or contributed by users. The training address texts may be determined by modifying address texts in the known corpus based on a particular semantic rule. The semantic rule may include a rule of substituting the entirety or part of an address text with one or more synonyms or near-synonyms. In some embodiments, the semantic rule may include a rule of combining at least two training address texts in the known corpus. In some embodiments, the semantic rule may include a rule of substituting a part of a training address text with a counterpart. For example, the training text is “Metropolitan Museum of Art 1000 5th Ave New York.” The segment “New York” may have a synonym “NYC.” The segment “Metropolitan Museum of Art” may have a synonym “the Met.” Based on the semantic rule, three new training texts may be determined. The three new training texts may include, “Metropolitan Museum of Art 1000 5th Ave NYC,” “the Met 1000 5th Ave NYC,” and “the Met NYC.” In some embodiments, the determination module 430 may categorize the training texts into a coarse-grained category and a fine-grained category.

In step 720, the training module 420 may determine a plurality of sets of training segments, each set of training segments corresponding to one of the plurality of training address texts. A training address text may consist of a set of training segments. For example, when the training address text is “Metropolitan Museum of Art 1000 5th Ave New York”, the set of training segments may include “Metropolitan Museum of Art,” “1000 5th Ave,” and “New York.” The training segments may be determined manually or from a thesaurus, a dictionary, an encyclopedia, etc. In some embodiments, the plurality of sets of training segments may include multiple segments corresponding to the plurality of training address texts in one or more known corpuses. The plurality of sets of training segments may include an expansion of the multiple segments based on one or more synonyms of the multiple segments. For example, the segment “New York” may have a synonym “NYC.” For another example, the segment “Metropolitan Museum of Art” may have a synonym “the Met.”

In step 730, the training module 420 may determine an initial segmentation model. The initial segmentation model may include a CRF model, a hidden Markov Model (HMM), a neural network (NN) model, etc. The initial model may have multiple layers. The initial model may have more than one initial parameter.

In step 740, the training module 420 may determine the first segmentation model based on the initial segmentation model, the plurality of training address texts, and the plurality of sets of training segments. The initial model may take a training address text as an input and determine a set of actual segments as an actual output. The training module 420 may determine a desired output based on the set of training segments. Each of the plurality of training address texts may have an actual output determined by the initial segmentation model and a desired output. For example, the actual segments for “Metropolitan Museum of Art 1000 5th Ave New York” may include “Metropolitan,” “Museum of Art,” “1000 5th Ave,” and “New York.” The training module 420 may train the initial model to minimize the output of a loss function. The loss function may indicate a difference between the desired output and the actual output determined by the initial model. Specifically, when the actual output is identical to the desired output, the output of the loss function is 0. The minimization of the loss function may be iterative. The iteration of the minimization of the loss function may end when the value of the loss function is less than a predetermined threshold. The predetermined threshold may be set based on various factors, including a number of the plurality of training address texts, an accuracy of the first segmentation model, etc. The training module 420 may iteratively adjust the initial parameters of the initial model during the minimization of the loss function. At the end of the minimization of the loss function, the training module 420 may determine one or more final parameters and the first segmentation model.

In some embodiments, the first segmentation model may include a coarse-grained segmentation model and a fine-grained segmentation model. When the training module 420 obtains multiple training address texts, the training module 420 may divide the multiple training address texts into a coarse-grained category and a fine-grained category. The training module 420 may obtain a coarse-grained segmentation model based on the initial model and the training address texts with the coarse-grained category. The training module 420 may obtain a fine-grained segmentation model based on the initial model and the training address texts with the fine-grained category.

The above description is merely for illustrative purposes. It should be noted that those skilled in the art may contemplate additional or alternate steps besides the steps described in FIG. 7. For example, the flowchart 700 may further include transmitting the first segmentation model to the data storage 160 or any other components in the on-demand service system 100 by the communication module 440.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more non-transitory computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter lie in less than all features of a single foregoing disclosed embodiment.

We claim:

1. A system, comprising:
at least one storage medium including a set of instructions; and
at least one processor in communication with the at least one storage medium, wherein when executing the set of instructions, the at least one processor is directed to:
receive a first electrical signal including an address text;
operate logical circuits in the at least one processor to:
determine a first category of the address text based on a categorization model;
determine a first segmentation model based on the first category of the address text; and
determine one or more segments of the address text based on the first segmentation model.

2. The system of claim 1, wherein the at least one processor is further directed to operate the logical circuits in the at least one processor to:
label at least one character of the address text based on at least one position of the at least one character within the address text; and
determine the one or more segments based on the labeled at least one character.

3. The system of claim 1, wherein the first category of the address text includes a nature object, an area, a road, a building, or an entity.

4. The system of claim 1, wherein the at least one processor is further directed to operate the logical circuits in the at least one processor to:
determine whether at least two segments of the address text are correlated;
determine a compound word in response to a determination that the at least two segments are correlated;
determine a second category of the compound word based on the compound word and the categorization model;
determine a second segmentation model based on the second category of the compound word; and
determine a first segment and a second segment based on the second segmentation model and the compound word.

5. The system of claim 4, wherein the at least two segments are adjacent n the address text.

6. The system of claim 1, wherein the at least one processor is further directed to operate the logical circuits in the at least one processor to:
determine whether one of the one or more segments of the address text is registered in a thesaurus; and
in response to a determination that the one of the one or more segments is not in the thesaurus, register the segment in the thesaurus.

7. The system of claim 1, wherein to determine the first segmentation model, the at least one processor is directed to operate the logical circuits in the at least one processor to:
obtain a plurality of training address texts;
determine a plurality of sets of training segments, each set of training segments corresponding to one of the plurality of training address texts;
determine an initial segmentation model; and
determine the first segmentation model based on the initial segmentation model, the plurality of training address texts, and the plurality of sets of training segments.

8. A method implemented on a computing device having at least one processor, at least one computer-readable storage medium, and a communication platform to connect to a network, the method comprising:
receiving a first electrical signal including an address text;
operating logical circuits in the at least one processor to:
determine a first category of the address text based on a categorization model;
determine a first segmentation model based on the first category of the address text; and
determine one or more segments of the address text based on the first segmentation model.

9. The method of claim 8, further comprising operating the logical circuits in the at least one processor to:
label at least one character of the address text based on at least one position of the at least one character within the address text; and
determine the one or more segments based on the labeled at least one character.

10. The method of claim 8, wherein the first category of the address text includes a nature object, an area, a road, a building, or an entity.

11. The method of claim 8, further comprising operating the logical circuits in the at least one processor to:
determine whether at least two segments of the address text are correlated;
determine a compound word in response to a determination that the at least two segments are correlated;
determine a second category of the compound word based on the compound word and the categorization model;
determine a second segmentation model based on the second category of the compound word; and
determine a first segment and a second segment based on the second segmentation model and the compound word.

12. The method of claim 11, wherein the at least two segments are adjacent in the address text.

13. The method of claim 8, further comprising operating the logical circuits in the at least one processor to:
determine whether one of the one or more segments of the address text is registered in a thesaurus; and
in response to a determination that the one of the one or more segments is not in the thesaurus, register the segment in the thesaurus.

14. The method of claim 8; wherein the first segmentation model is determined by the following steps:
operating the logical circuits in the at least one processor to:
obtain a plurality of training address texts;
determine a plurality of sets of training segments, each set of training segments corresponding to one of the plurality of training address texts;
determine an initial segmentation model; and
determine the first segmentation model based on the initial segmentation model, the plurality of training address texts; and the plurality of sets of training segments.

15. A non-transitory computer readable medium embodying a computer program product, the computer program product comprising instructions configured to cause a computing system to:
receive a first electrical signal including an address text;
operate logical circuits in the at least one processor to:
determine a first category of the address text based on a categorization model;
determine a first segmentation model based on the first category of the address text; and
determine one or more segments of the address text based on the first segmentation model.

16. The non-transitory computer readable medium of claim 15, wherein the computer program product further comprises instructions configured to cause the computing system to operate the logical circuits in the at least one processor to:
label at least one character of the address text based on at least one position of the at least one character within the address text; and
determine the one or more segments based on the labeled at least one character.

17. The non-transitory computer readable medium of claim 15, wherein the first category of the address text includes a nature object, an area, a road, a building, or an entity.

18. The non-transitory computer readable medium of claim 15, wherein the computer program product further comprises instructions configured to cause the computing system to operate the logical circuits in the at least one processor to:
determine whether at least two segments of the address text are correlated;
determine a compound word in response to a determination that the at least two segments are correlated;
determine a second category of the compound word based on the compound word and the categorization model;
determine a second segmentation model based on the second category of the compound word; and
determine a first segment and a second segment based on the second segmentation model and the compound word.

19. The non-transitory computer readable medium of claim 18, the at least two segments are adjacent in the address text.

20. The non-transitory computer readable medium of claim 15, wherein to determine the first segmentation model, the computer program product further comprises instructions configured to cause the computing system to operate the logical circuits in the at least one processor to:
obtain a plurality of training address texts;
determine a plurality of sets of training segments, each set of training segments corresponding to one of the plurality of training address texts;
determine an initial segmentation model; and
determine the first segmentation model based on the initial segmentation model, the plurality of training address texts, and the plurality of sets of training segments.
